(19) United States
(12) Patent Application Publication
(10) Pub. No.: US 2023/0132654 A1
(43) Pub. Date: May 4, 2023

(54) INTEGRATED AGRICULTURE INFORMATION AND MANAGEMENT SYSTEM, AND METHODS OF USING THE SAME

(71) Applicant: Venkatesh B. VADLAMUDI, NOVI, MI (US)

(72) Inventor: Venkatesh B. VADLAMUDI, NOVI, MI (US)

(21) Appl. No.: 18/084,134

(22) Filed: Dec. 19, 2022

Related U.S. Application Data
(63) Continuation-in-part of application No. 16/908,124, filed on Jun. 22, 2020.
(60) Provisional application No. 62/864,238, filed on Jun. 20, 2019.

(51) Int. Cl. G06Q 10/0833; G06Q 50/02

(52) U.S. Cl. CPC G06Q 10/0833; G06Q 50/02

(57) ABSTRACT

An integrated agriculture information and management system (AIMS) for supplying and managing movement of a produce from a farmer to a retailer includes a plurality of organizations each having a enterprise resource planning (ERP) module including one or more processors; and a plurality of channels which selectively share business data between the ERP modules of the plurality of organizations, such as a farmer organization, a harvesting organization, a warehousing organization, a distribution and processing organization, a business organization, and a retailer organization. The plurality of the organizations are connected each other via the channels. The movement of the produce from the farmer organization to the retailer organization is recorded in real time and instantaneously, and when the produce is delivered to the retailer organization, the one or more processor selectively cause the business organization to release of payments to at least one of the plurality of organizations.

### CROSS-REFERENCE TO RELATED APPLICATIONS

The present application is continuation-in-part of U.S. patent application Ser. No. 16/908,124, filed on Jun. 22, 2020, which claims priority under 35 USC § 119 to U.S. Provisional Patent Application No. 62/864,238, filed on Jun. 20, 2019. The entire subject matter of this priority document, including specification, claims and drawings thereof, is incorporated by reference herein.

### BACKGROUND OF THE INVENTION

### 1. Field of the Invention

The present invention relates to an integrated agriculture information management system (also referred to as dFarm product, dFarm system, AIMS system), and methods of using the same. More particularly, the present invention relates to an integrated agriculture information and management system, in which the movement of the produce from a farmer organization to a retailer organization is recorded in real time and instantaneously in the plurality of organizations, and when the produce is delivered to the retailer organization, the one or more processor selectively cause the business organization to release of payments to the farmer organization, the harvesting organization, the warehousing organization, and the distribution and processing organization for the produce delivered to the retailer organization.

### 2. Description of Related Art

It has been recognized that, globally a total of about 1.3 billion tons, or one-third of the edible part of food originally intended for human consumption is wasted annually. Such wastage of food is estimated to cost nearly one trillion US Dollars ($1,000,000,000,000) per year. In addition, in the existing systems, the operational chain of selling produce from farmers to consumers requires an army of middlemen, agents and brokers, who mostly charge hefty commissions to farmers while dictating unfair prices to both the farmers and consumers. Moreover, in the existing systems, farmers and/or retailers/consumers are not equipped to track and trace the produce they are selling/buying. Farmers, specifically those who produce smaller quantities of produce, are definitely not equipped with or have no means to extend shelf life of their produce and must sell their harvest quickly or lose the much-needed revenue. In addition, many farmers rely heavily on the use of pesticides in large quantities mainly due to possible lack of good agricultural practices or farm management.

Another drawback of the existing system is that consumer prices are heavily inflated due to improper and inadequate systems implemented in dealing with agricultural produce by middlemen, e.g., brokers. For example, in developing countries like India, consumer prices are sometimes inflated by 500% to 2500% for agricultural produce, due to the lack of good solid agriculture information and having a strong farm management system in place.

A significant number of small and/or new farmers are unfavorably treated by lenders, such as banks, for loans they seek for implementation of advanced farming practices. For example, banks are reluctant to extend loans to small framers to use for advance farming practices, such as, hydroculture farming including hydroponic farming which involves a method of growing plants in mineral nutrient solutions in a water solvent without using soil. In general, banks are not able to assess farmers assurance of repayments of loans due to lack of efficient system for selling agricultural produce by farmers to retailers/consumers. Most of the times, small farmers are not able to produce authenticated documentation for advanced farming practices to secure loans from lenders due to lack of a robust, efficient system such as an integrated agriculture information and farm management system described herein, which would provide certification and/or documentation for loan applications and help the banks make favorable decisions.

Another drawback for existing agricultural produce system in most countries is that of corporate farming. It is well recognized that corporate farming has badly affected small, cottage farmers, who grows different, exotic varieties of agricultural produce. Small farmers are defined under US laws. For example, according to the USDA definition, a small farmer is defined as one that grows and sells agriculture produce between $1,000 and $250,000 per year. The applicant in the current system, considers a farmer being a small farmer who is not engaged in corporate farming. It may be noted that according to the U.S. Labor Department, the average age of farmers and ranchers is 58 years old and this age has been increasing over the last 30 years, according to the U.S. Department of Agriculture's Census of Agriculture. In view of this, nationally, ⅔ of all farmland will need a new farmer in just 15 to 20 years.

The present invention attempts to overcome the drawbacks of the existing agricultural information and management system. Accordingly, one of the benefits of the present invention is to provide a more efficient integrated agriculture information and management system (also referred to as dFarm product, dFarm system, AIMS system), augmented and integrated with blockchain technology, internet of things, and artificial intelligence, etc. Such a dFarm system would be operable to collectively and/or selectively share agricultural produce information and manage a number of operations including streamlining the pickup, transportation, logistics, storage, etc., of agricultural produce from numerous small farmers to numerous retailers and/or consumers. Also, the AIMS system would provide guidance to farmers on growing a variety of fruits, vegetables and processing thereof in a very efficient manner.

Another object of the present invention is to provide an integrated agriculture information and management system, which would promote improved agricultural practices by providing access to better forecasting, planning, improved produce quality, more efficient logistics, increased shelf life and better access to markets and better pricing. The present invention is aimed at improving the profitability of farming operations for small farmers, improving farmers' produce marketability in additional avenues, such as direct consumer marketing. Educating farmers to find answers to agriculture threats and weaknesses, will make farming activity a more viable business, supporting farm agencies and state agriculture departments, etc. The dFarm system also contains a farmer's assistance module.

Furthermore, another object of the present invention is to provide an integrated agriculture information management system, which will enable farmers' access to extended value-added services on their produce and help make their farms run more efficiently and provide better faster and easier market access. Also, the dFarm system is configured to provide a value-added perspective of technology in agriculture and farming. In addition, the dFarm system would assist with a more efficient farming, to achieve significant reduction in farm produce wastage (which is a growing problem in today's world) using a more efficient routing of the produce to retailers and/or consumers. This faster market access also assures to the retailers to have the produce on their shelves longer for consumer to buy reducing spoilage/wastage. Next, the dFarm system of the present invention aims at assuring farmers a minimum viable price (MVP) for their produce by reducing steps or channels, e.g., numerous brokers involved in moving produce from the farms to retailers/consumers.

### SUMMARY OF THE INVENTION

The present embodiments according one aspect thereof provides an integrated agriculture information and management system (AIMS) for supplying and managing movement of a produce from a farmer to a retailer includes a plurality of organizations each having a enterprise resource planning (ERP) module including one or more processors; and a plurality of channels which selectively share business data between the ERP modules of the plurality of organizations, such as a farmer organization, a harvesting organization, a warehousing organization, a distribution and processing organization, a business organization, and a retailer organization. The plurality of the organizations are connected each other via the channels. The movement of the produce from the farmer organization to the retailer organization is recorded in real time and instantaneously, and when the produce is delivered to the retailer organization, the one or more processor selectively cause the business organization to release of payments to at least one of the plurality of organizations

The present embodiment according another aspect thereof provides an integrated agriculture information and management system for managing a produce from a farmer to a retailer. The integrated agriculture information and management system includes a plurality of modules including a central processing module comprising data management unit, analytics unit, business case making analysis unit, functionality unit, customer relationship management unit and financial unit; a harvesting module operable to provide information related to harvesting of produce to the central processing module; a vendors module comprising cold storage unit, pack house unit, processing center, distribution center, transportation unit and bankers unit, each operable to provide and seek information from the central processing unit; and a retailer module. The plurality of modules are selectively and operatively connected with each other, and each of the plurality of modules is augmented and integrated with at least one of blockchain technology, internet of things, artificial intelligence, the customer relationship management, and application programming interface such that movement of the produce is recorded in real time and instantaneously, and when the produce is delivered to the retailer, the farmer and vendors are automatically paid for the produced delivered to the retailer.

As indicated above, the dFarm product has integrated Blockchain business network including selectively and/or collectively shareable, replicable and immutable Blockchain technologies like hyperledger fabric. Furthermore, in the dFarm system, the IoT is integrated at different stages of operations using several connectivity options. The dFarm system is augmented and automated with AI.

An embodiment according to another aspect thereof, provides the AIMS system having several modules including a central processing module including a central processing computer, a routine notification unit, an alarm device unit; a harvesting module comprising a farmer using a handheld device, a farm computer, a farm produce recording device; a bin bar coding module including a binning handheld device, movement of the agriculture produce, a barcode generating device, a printer; a first shipping and handling (first shipping) module including an environmentally controlled carrier, a first shipping handheld device; a cold storage module including a environmentally controlled structure; a processing module including a processing center, a first processing computer, a processing handheld device; a container bar coding module including a second shipping and handling module; a distribution module; a delivery module; a consumer module including a retailer module and a direct consumer module; a finance module including an integrated secure payment system. Various technologies such as Blockchain, IoT, AI, customer relationship management (CRM), application programming interface (API) etc., are associated with many different modules or different combination of modules.

The numerous modules are selectively and operatively connected with each other. The above-described system of another embodiment has a modular structure such that some modules may be removed, and/or additional modules may be added. The number of modules which are operable to record the journey/movement of all agriculture produce from one point to the other and users of the systems can easily retrieve location information of the produce.

According another embodiment, an integrated agriculture information and management system (AIMS) for supplying and managing movement of a produce from a farmer to a retailer includes a plurality of organizations each having a enterprise resource planning (ERP) module including one or more processors; and a plurality of channels which selectively share business data between the ERP modules of the plurality of organizations, such as a farmer organization, a harvesting organization, a warehousing and packaging organization, a distribution and processing organization, a business organization, and a retailer organization. The plurality of the organizations are connected each other via the channels. The movement of the produce from the farmer organization to the retailer organization is recorded in real time and instantaneously, and when the produce is delivered to the retailer organization, the one or more processor selectively cause the business organization to release of payments to at least one of the plurality of organizations.

When the price of the produce is declared by the farmer organization, each of the plurality of the organizations except for the farmer organization receive a corresponding preset service charge payment for the produce delivered to the retailer organization such that the price of the produce cannot be inflated or deflated by the plurality of the organizations. The warehousing and packaging organization is configured to create a QR code which includes information related to farmer organization including farmer demographics, farm compliances, and cost of the produce and harvesting date and time declared by the farmer organization, and the QR code is continually updated as the produce moves from the warehousing and packaging organization to the plurality of the organizations including the retailer organization.

For a more complete understanding of the present invention, the reader is referred to the following, non-limiting, detailed description section, which describes an exemplary embodiment of the present invention and should be read in conjunction with the accompanying drawings. Such exemplary embodiment is provided for illustration and better understanding of the present invention and is not intended to limit the invention. Throughout the following detailed description and in the drawings, like numbers refer to like parts.

### BRIEF DESCRIPTION OF THE DRAWINGS

FIG. 1 shows outline of problem of existing produce selling system.

FIG. 2 shows a view of existing produce selling system adapted by small farmers.

FIG. 3 shows AIMS operation model according to a first embodiment.

FIG. 4 shows outline of solution including application of a shared, replicated hyperledger.

FIG. 5 shows a view of the AIMS blockchain business network.

FIG. 6 shows AIMS blockchain participants and hyperledger.

FIG. 7 shows an illustration of a functioning internet of things.

FIG. 8 shows different internet of things (IoT) connectivity operations.

FIG. 9 shows an illustration of artificial intelligence (AI) in the AIMS.

FIG. 10 shows a view of selling and connecting system according to AIMS technology.

FIG. 11 shows another embodiment of the AIMS system.

FIG. 12 shows existing ERP solutions.

FIG. 13 shows dFarm Next Gen ERP AIMS including various organizations and channels according to a second embodiment.

FIG. 14 illustrates architecture based flow of produce.

FIG. 15 illustrates ERP data pushed via user interface (UI).

FIG. 16 illustrates transaction receiver module call flow.

FIG. 17 illustrates basic flow for invoice and payments.

FIG. 18 illustrates IOT based structure

FIG. 19 illustrates inbuilt AI framework for data processing and dashboard display.

FIG. 20 illustrates a profound global impact of the AIMS showing the AIMS meeting the objective of Sustainable Development Group of the United Nations.

FIG. 21 illustrates distributed ERP suite.

FIG. 22 illustrates AIMS Software as a Service (SaaS) platform working model.

FIG. 23 illustrates transformed dFarm value chain.

### DETAILED DESCRIPTION

### First Embodiment

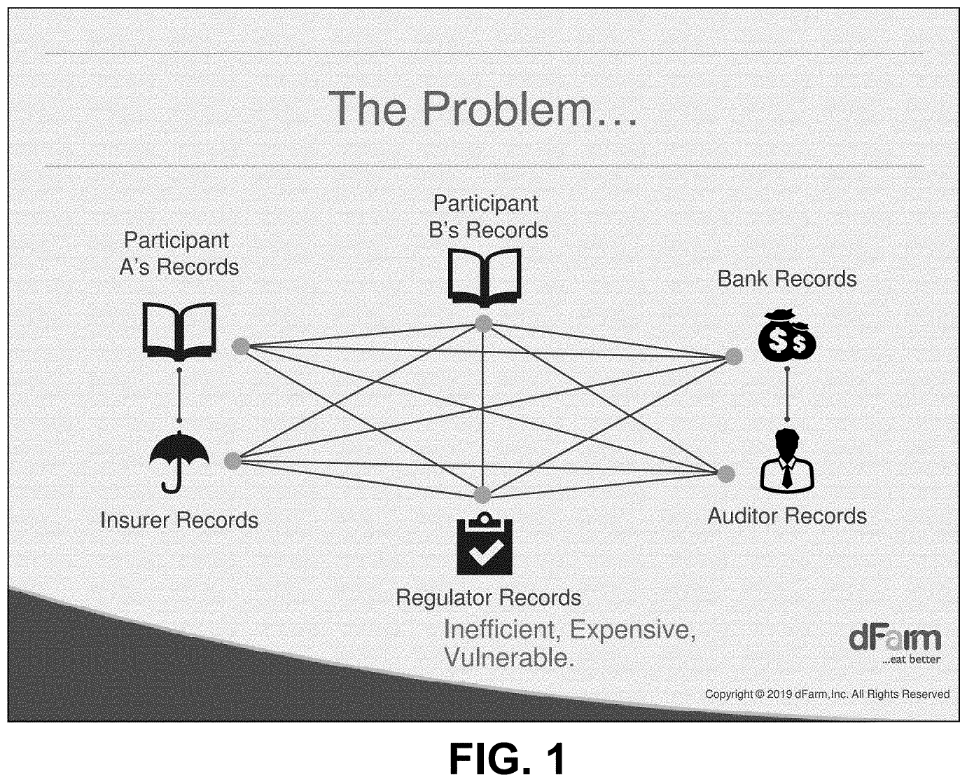

The existing system is inefficient, expensive and vulnerable to manipulation by participants using the system, and/or by external people. Such inefficient, expensive and vulnerable system E1 used for managing and selling produce is depicted in FIG. 1.

It can be noted based on FIG. 1 that the existing system does not have a trusted, replicated, hyperledger which has shared business process across all the members of the business network. Rather, it has only selectively shared business process among only a few participants of the business network. Moreover, the existing system lacks coordination and communication among the participants. Also, the existing system does not have internet of things integrated therewith for automatically tracing produce. Further, the existing system does not have artificial intelligence integrated with the system. Rather, for example, as shown in FIG. 1, the existing system has participant A's records PA, participant B's records PB, bank records BR, auditor records AR, regulator records RR and insurance records IR. Since these records do not have a common trusted and replicated hyperledger and/or are not modulated, the existing system is inefficient, expensive and vulnerable to security attacks.

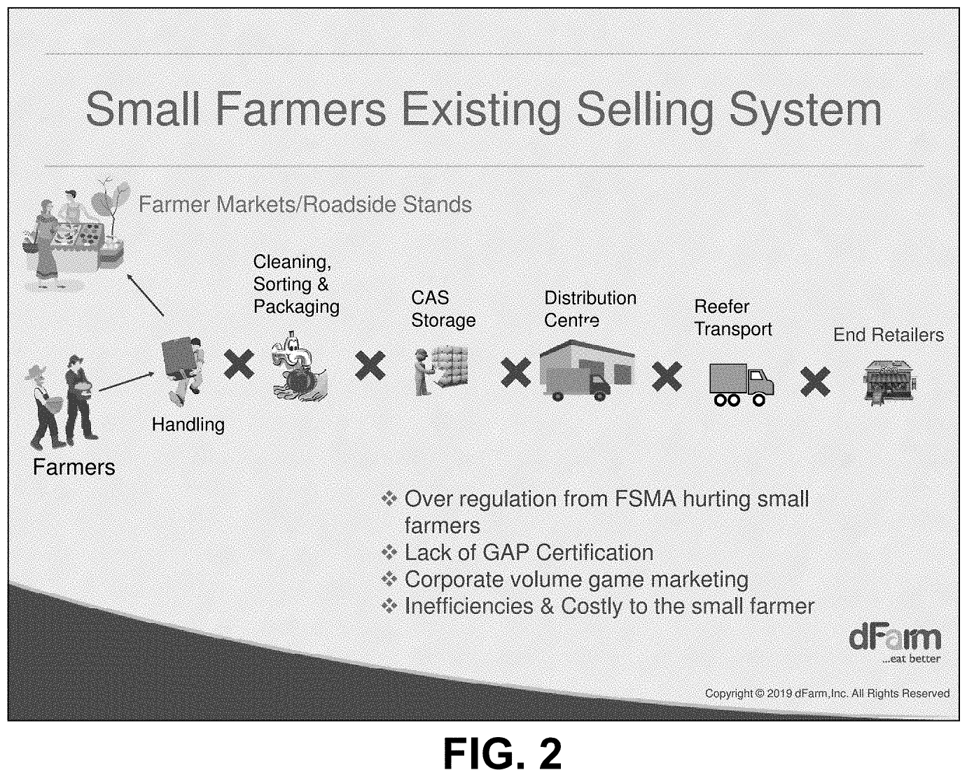

An existing selling system for small farmers' produce is illustrated in FIG. 2. In the existing selling system E2, there are several components which are not modulated and/or coordinated. Such components include famers providing and/or handing produce to famers markets/roadside stands.

It can be seen from FIG. 2 that the existing selling system lacks coordination and connectivity among various tasks involved in system, e.g., handling HS; cleaning CS, sorting SS and packaging PK, control Atmosphere storage CAS, distribution center DC, reefer transport RT, end retailers ER, etc. It may be noted that CAS is a storage mechanism in which fixed data is assigned a permanent location on a hard disk and addressed with a unique content name, identifier and/or address. Again, the system shown in FIG. 2 does not have integrated and/or augmented blockchain technology, internet of things and artificial intelligence.

It is generally recognized that over regulations, mostly government regulations, such as Good Agriculture Practice (GAP), Food Safety Modernization Act (FSMA) hurts small farmers. The FSMA has been effective since 2011. Under this Act, food companies including small farmers are required to develop food safety plans based on an evaluation of hazards related to food manufactured, processed, packed or held in all registered facilities. Furthermore, the most of the times small farmers cannot afford and/or lack good agricultural practices (GAP) certification. GAP was formally implemented by the United States Department of Agriculture (USDA) and Food and Drug Administration (FDA) in 2002. It is a voluntary audit program designed for the fruit and vegetable production industry to verify that the produce is grown, packed, handled, and stored as safely as possible. These audits check for adherence to the FDA's production guide and recognized industry food safety practices.

Moreover, the small farmers are unable to compete with big, corporate farms mainly due to corporate volume game marketing strategy. Overall, the existing system is inefficient and costly to small farmers and does not benefit small farmers.

The first embodiment provides an integrated information and management system, which is also referred to as dFarm product, dFarm system, AIMS system.

An outline of dFarm product of the present invention including its purpose, reference definitions, its scope summary, exemplary participants of the system/product, produce traceability, illustrative app screens, is provided in Annex-A, which was filed in applicant's provisional patent application USSN 62/864,238, which is incorporated herein by reference.

A dFarm product presentation of this invention including objectives, illustrations of the dFarm product in detail are provided in Annex-B, which was filed in applicant's provisional patent application USSN 62/864,238, which is incorporated herein by reference.

A dFarm product document of the present invention including brief information of the dFarm product and various modules of the system including farm management, inventory and warehouse, logistics, business to business modules, finance, admin, technology, etc., is provided in Annex-C, which was filed in applicant's provisional patent application USSN 62/864,238, which is incorporated herein by reference.

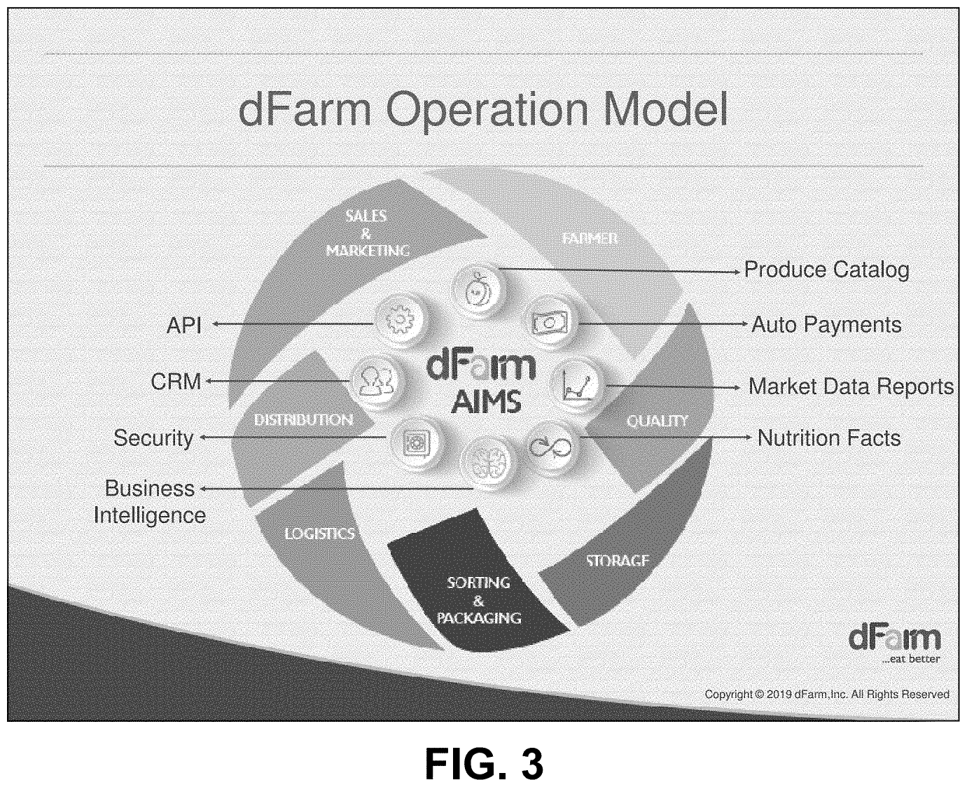

The dFarm operation model according to the first embodiment is shown in FIG. 3. The operation model includes a number of modules, such as produce catalog PC, automatic payments AP, market data reports MDR, nutritional facts NF, business intelligence BI, security S, customer relationship management CRM, application programming interface API, etc. These modules are appropriately coordinated for various functions including farmer offering farm produce before or after actual harvesting of the produce, quality assurance, storage needs, sorting and packaging, logistics, distribution and sales and marketing.

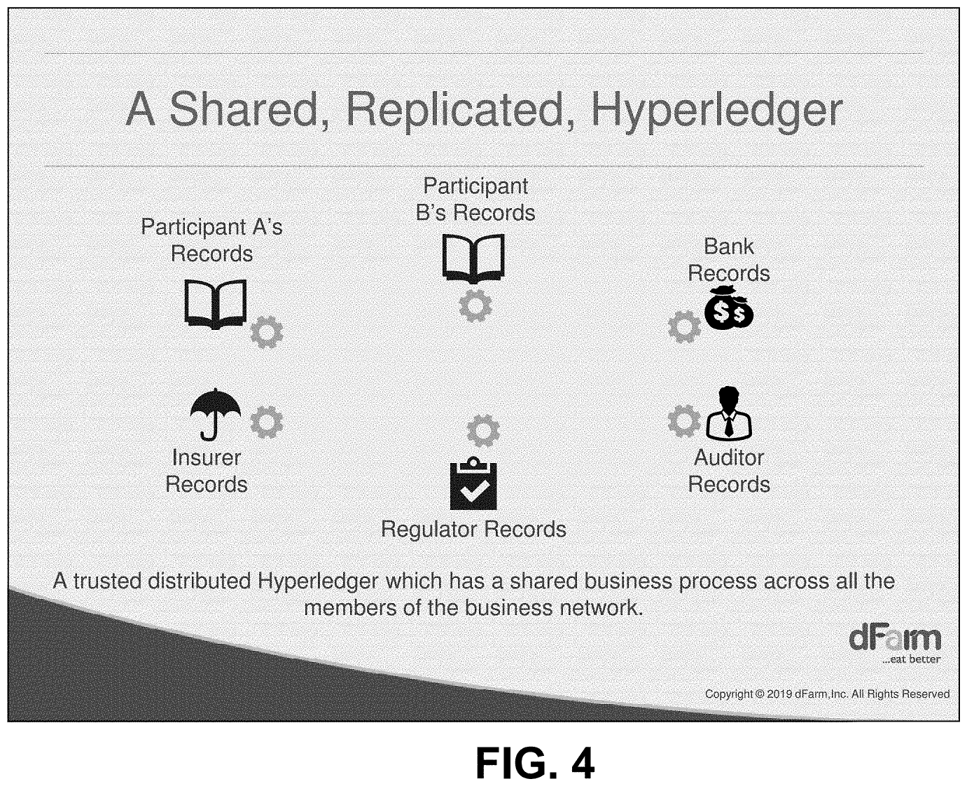

As show in FIG. 4, the present invention provides the dFarm system augmented with the information technology having a trusted distributed hyperledger fabric HF which has shared business processes in its entirety across all the members of the business network, e.g., participant A's records PA, participant B's records PB, bank records BR, auditors record AR, regulatory records RR, and insurer records IR. The dFarm system is configurable such that the hyperledger fabric HF may be shared only with a few selected members. Also, such a technology has a shared, replicated hyperledger fabric that is accessible to a few selected or to all the members of the business network during its process.

It may be noted that hyperledger fabric HF is a permissioned blockchain infrastructure providing a modular architecture with a delineation of roles between the nodes in the infrastructure, execution chaincodes in fabric and configurable consensus and membership services. A fabric network includes peer nodes, which execute chaincode, access ledger data, endorse transactions and interface with applications. Orderer nodes which ensure the consistency of the blockchain and deliver the endorsed transactions to the peers of the network, and Membership Service Providers (MSPs), generally implemented as a Certificate Authority.

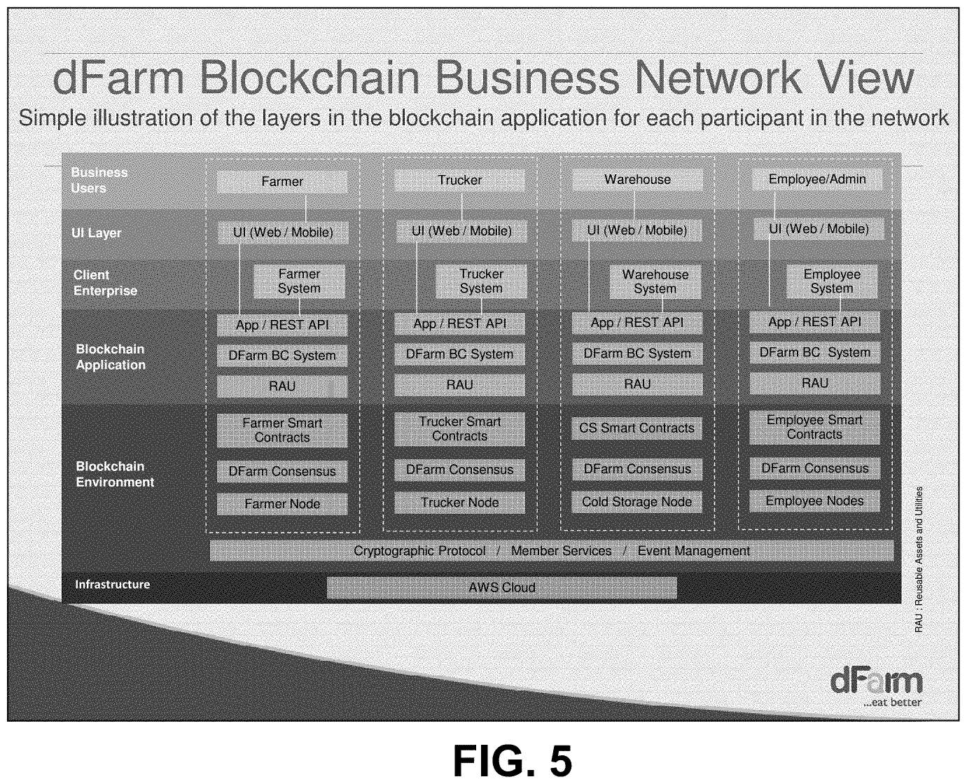

The dFarm product has integrated a Blockchain business network. A typical view of dFarm blockchain business network is shown in FIG. 5. The main layers in blockchain are business users, user interface (UI) layer, client enterprise, blockchain application and blockchain environment. As shown in FIG. 5, each of the layers includes several components. For example, business users layer include: the farmer, trucker, warehouse and employee/admin. The client enterprise includes a farmer system, a trucker system, a warehouse system and an employee system.

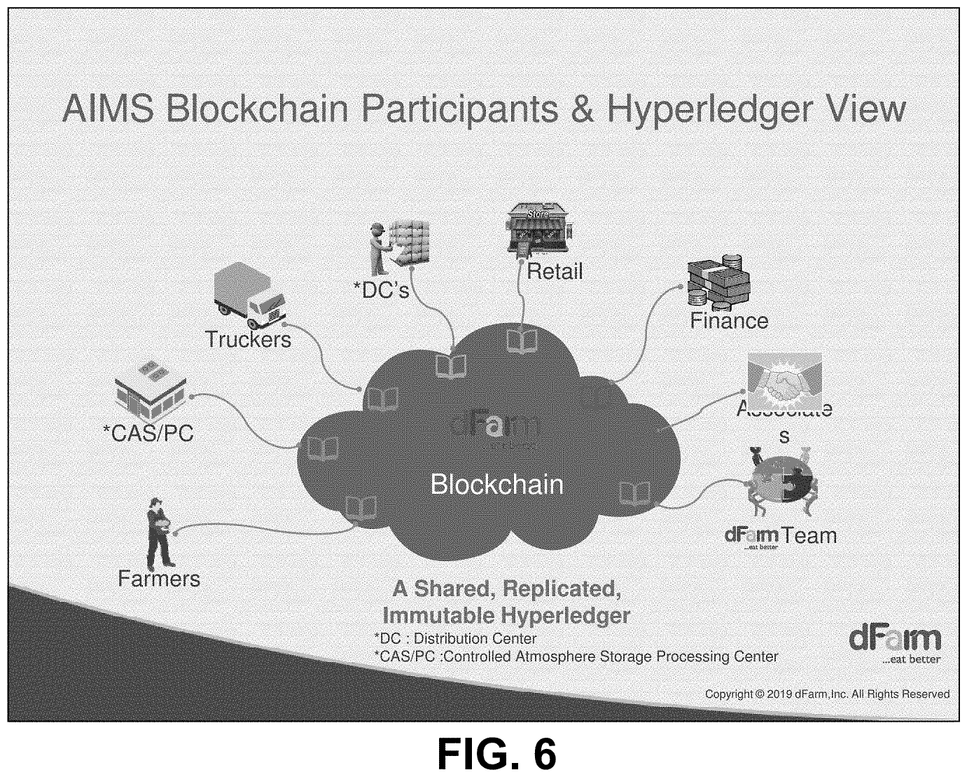

According to the dFarm system of the present invention, participants in the system are connected with each other through a shared, replicated, immutable hyperledger fabric created by using the blockchain technology. An example of such a connectivity of the participants via application of blockchain technology in the dFarm system is shown in FIG. 6. As it can be seen from FIG. 6, a shared, replicated and immutable hyperledger HF is shared with farmers, storage (CAS/PC), truckers, distribution centers (DC), retailers, finance, accounts and dFarm team.

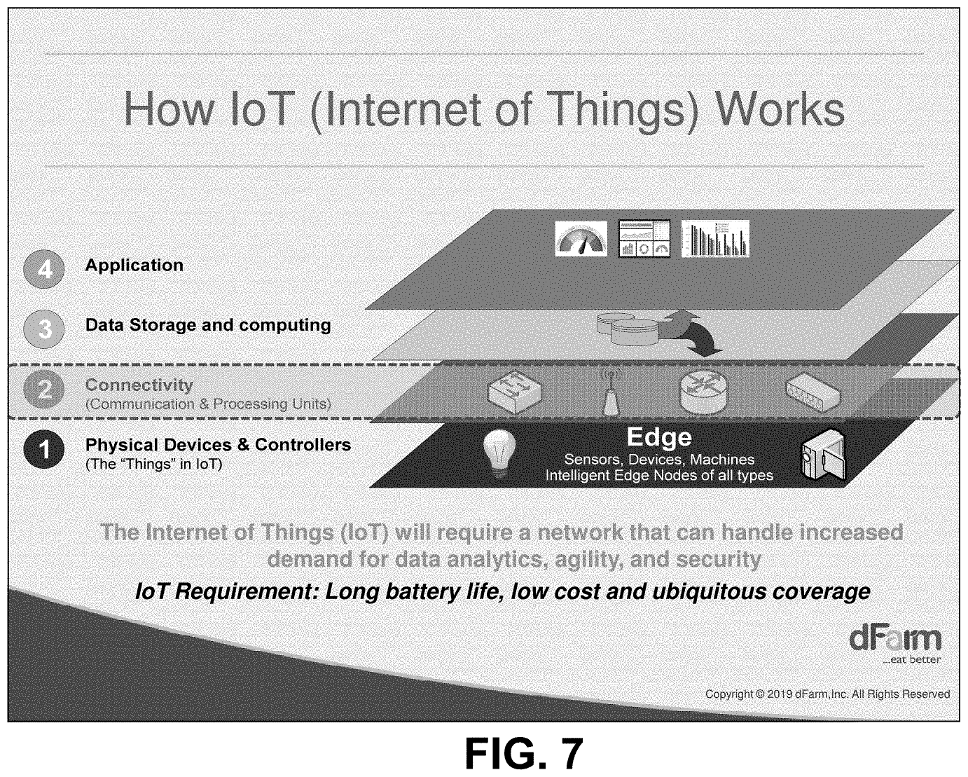

Furthermore, in the dFarm system, the Internet of Things (IoT) is integrated at different stages. The IoT is the extension of internet connectivity into physical devices and everyday objects. The IoT equips with devices that can communicate and interact with others over the Internet, and they can be remotely monitored and controlled. The IoT generally requires a network that can handle increased demand for data analytics, agility and security. Other IoT requirements are long battery life, low cost and ubiquitous coverage. An illustration of how IoT works is provided in FIG. 7. The IoT technology is most synonymous with products pertaining to this concept are smart devices and appliances, e.g., thermostats, lighting fixtures, home security systems and cameras, refrigerators, etc. They also support one or more common ecosystems, such as smart phones. In the present system, the application of IoT may be extended to packaging, storage bins and containers containing the farmer's produce.

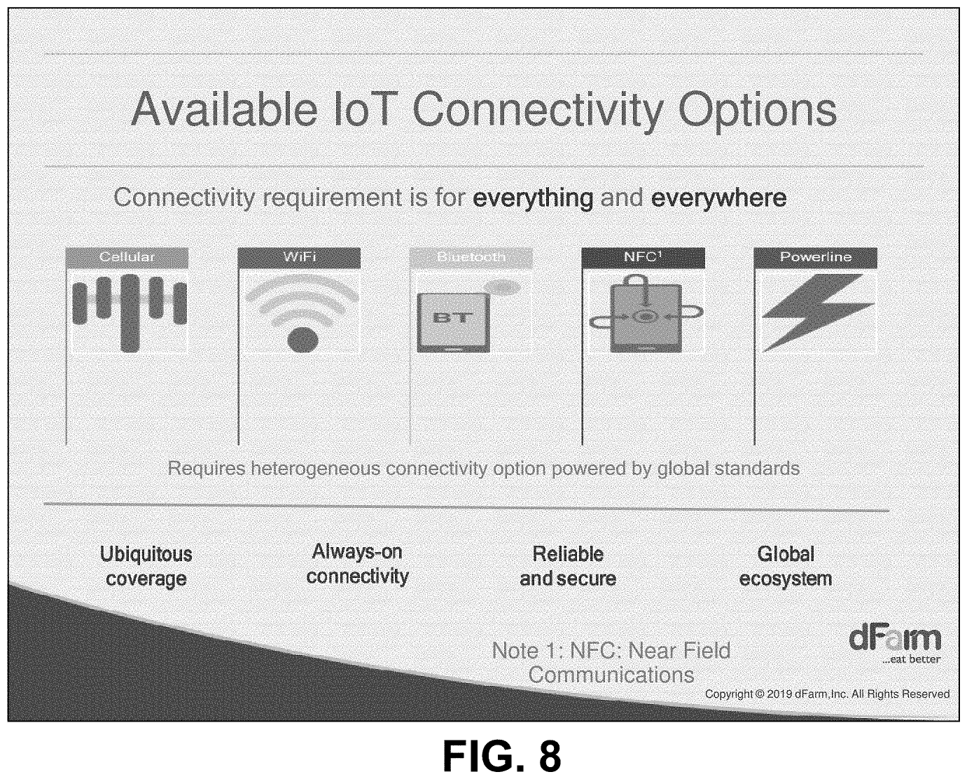

There are several IoT connectivity options used in the dFarm system. Examples of such connectivity options include: Cellular, WiFi, Bluetooth, Near Field Communications (NFC) and power lines. Such connectivity options are shown in FIG. 8. The dFarm system is further configurable to add additional new connectivity options or using a combination of options that is listed above.

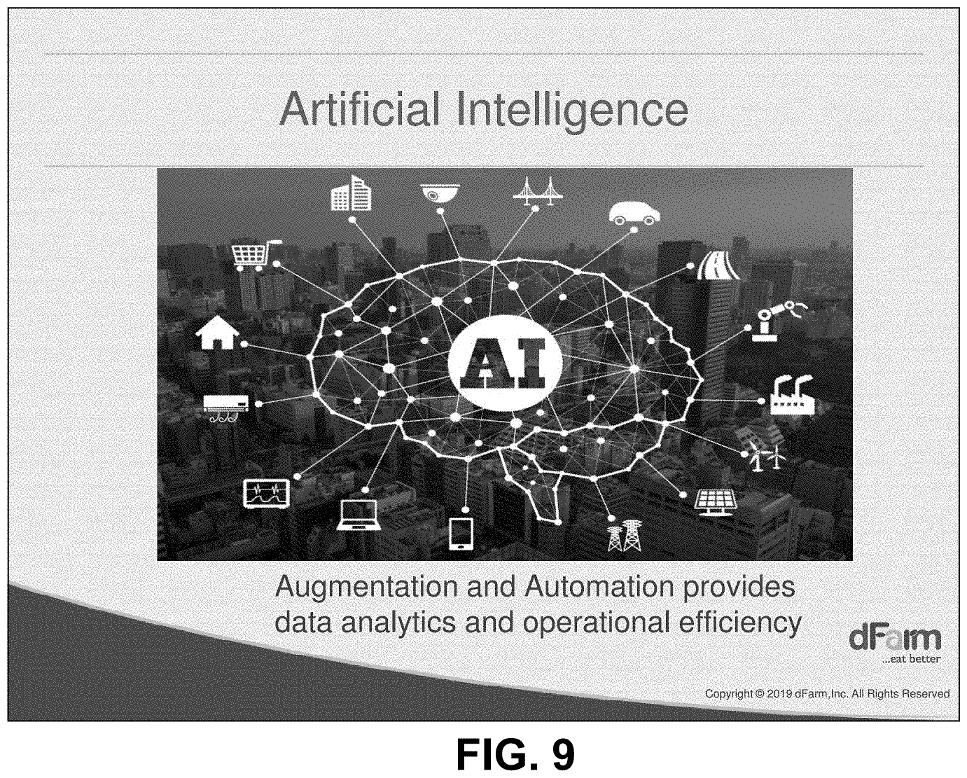

Next, the dFarm system is augmented with Artificial Intelligence (AI). This augmentation and automation of the dFarm system provides faster data analytics and operational efficiency for tracing logistics of agriculture produce. A general illustration of AI augmented with the dFarm system is shown in FIG. 9. AI which is a machine intelligence that is used to describe machines/computers that mimic “cognitive” functions that humans associate with other human minds, such as, learning and problem solving at a much faster speed.

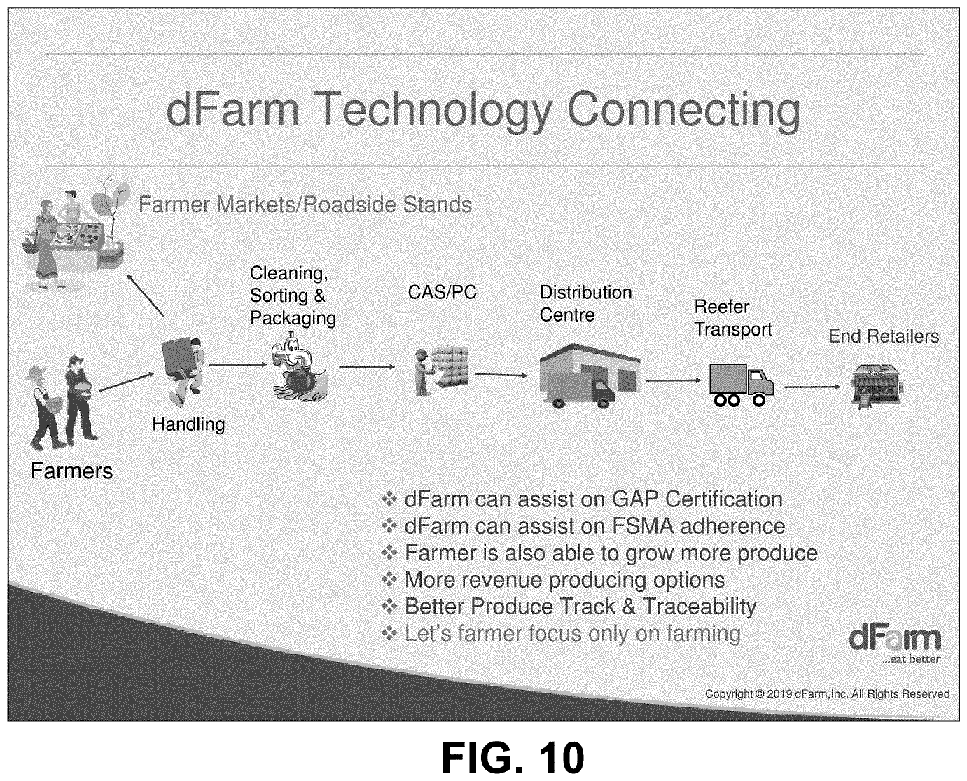

The present invention including the dFarm product provides efficient and reliable/replicable connectivity among various participants involved in the produce producing and selling system. FIG. 10 generally shows efficient movement of produce from small farmer to end retailers and consumers. In addition, the dFarm system is operable to and/or configurable to procure GAP certification and to provide assistance to comply with FSMA. Since the farmers have to spend less time on technical requirements of procuring GAP certification and/or complying with FSMA and also spend less time on selling his produce, farmers are able to grow more produce, have more revenue producing options, have better produce track and traceability and spend more time on actual core farming activity. The actual core farming activity is the activity, which is what farmers do best.

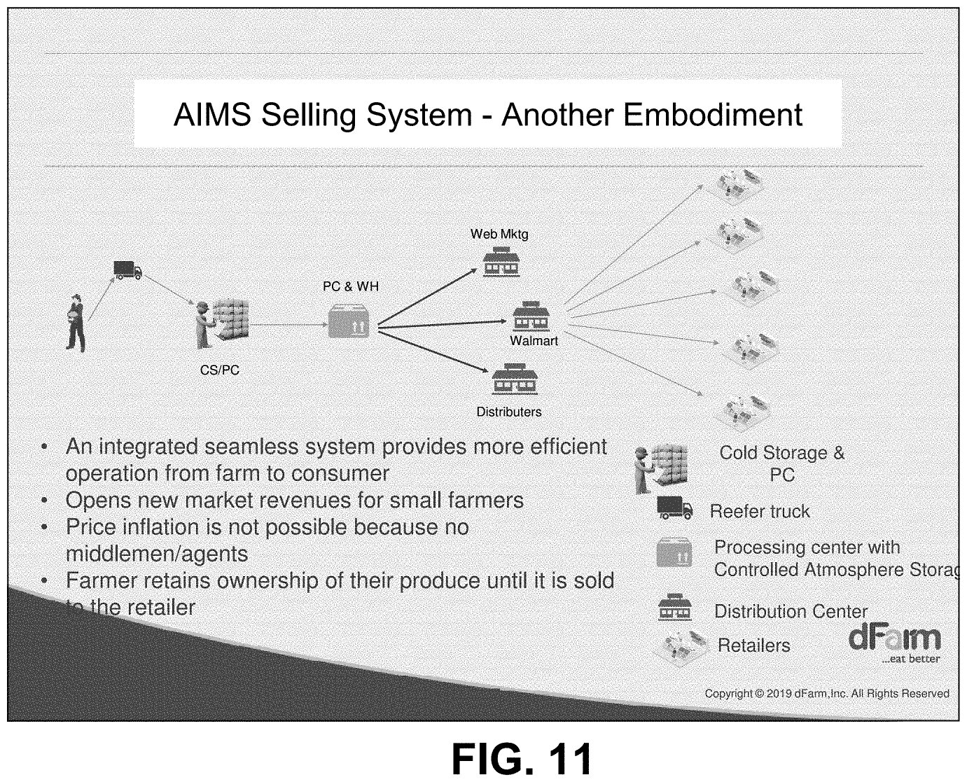

Another embodiment of dFarm selling system is shown in FIG. 11. This system is integrated into a seamless system that provides more efficient operation from farm to consumer, opens new market revenues for small farmers, minimizes/prevents price inflation due to elimination of middlemen/agents. Moreover, the farmers retain produce ownership and track it produce throughout this process until it is sold to the retailers.

Additional embodiments and details of the present invention are outlined in the Appendix-I, Appendix-II, Appendix-III and Appendix-IV of the parent application Ser. No. 16/908,124, each of which is incorporated herein by reference.

### Second Embodiment

The dFarm AIMS system is fresh produce focused, NextGen (Distributed) ERP Product that is built using latest innovation and breakthrough technology like blockchain, AI/ML. It uses these technologies to remove the data fragmentations issue existing in legacy ERP echo systems.

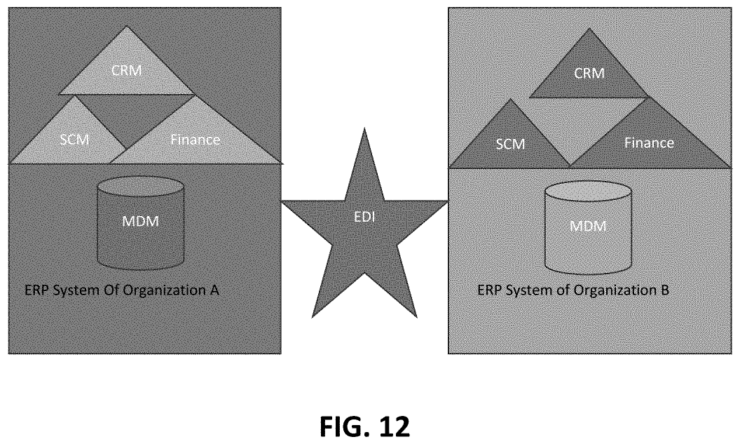

Existing ERP systems (such as shown in FIG. 12) are working in their own silos and not having any distributed system to share data with each other or even into their own modules in efficient ways. They only have options to share data via EDI (Electronic data Exchanges). That is having following bottleneck and issues, such as, due to centralized process for data exchange, it has single point of failure; it involved high data integration cost because both ERP echo systems work into their own worlds and need specific implementation of each customer needs; due to the offline nature of this process tracking of any asset or orders within an organization or between two organizations is very difficult; and generic ERP solutions are not built to implement specific processes and flow required in Ag Tech business.

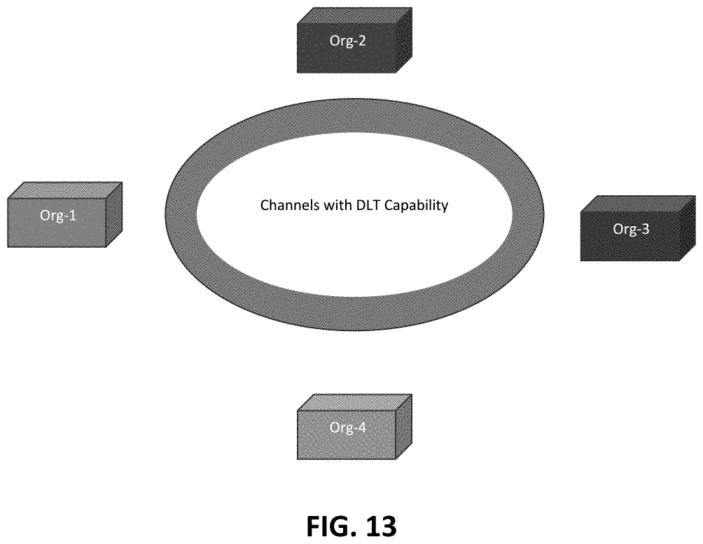

The second embodiment of AIMS-dFarm Next Gen ERP (also referred to as AIMS system) is illustrated in FIGS. 13-19. In the AIMS system, the channels is a logical data bus that is used to share business data between AIMS ERP Modules and different instances of ERP Product running for multiple clients (See FIG. 13). It provides a way to share secure and selective data between different entities on need-to-know basis. There can be multiple channels between or within an organization based on business needs and data sharing requirement. In context of AIMS ERP, organization can be Retailers, Farming Corporations, warehousing, distribution and processing centers running different modules or AIMS ERP Systems. They connected with each other via channels.

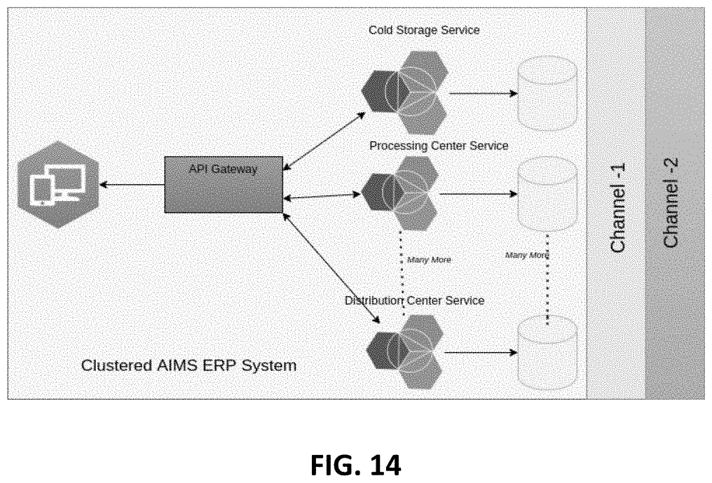

The Architecture Based. Flow is shown in FIG. 14. According to an embodiment, as discussed below, user interface, blockchain signer client, and distribution ledger interact with each other to create a pure. Distributed ERP Echo System as shown in FIG. 14.

User Interface: The user Interface is the entity from where Data (Invoice, Price, Registration, etc.) will be pushed to Blockchain Singer/Verifier client, it can be Web interface, Mobile interface or any other medium to generate ERP Data. There can be multiple instances of this module running within an organization however two instances of this module will not have inter connectivity between two organizations. This Module also has its own database to store local and private information.

Blockchain Signer Client: This Module works as backend to support Core ERP business logic and has sub module to initiate connection with distributed blockchain to create seamless data sharing within/across organizations. It has its own database or third-party wallet to store public/private key, required for new user registration and ERP data signature/verification.

Distributed Ledger: This module can be any distributed ledger blockchain (Fabric, Ethereum, Corda, etc.). This module has nodes running within each organization and they are connected with P2P (peer to peer) or gossip protocol to share data by using customized configuration that provide different level of privacy and confidentiality. It has capability to notify interested party (Organization) for specific transactions based on configured smart contract logic. Each node has its own copy of immutable data that can be only updated via consensus protocol and have all the safety provided by latest blockchain technology, means no single organization/entity is allowed to change the data without approval from all party in the distributed network.

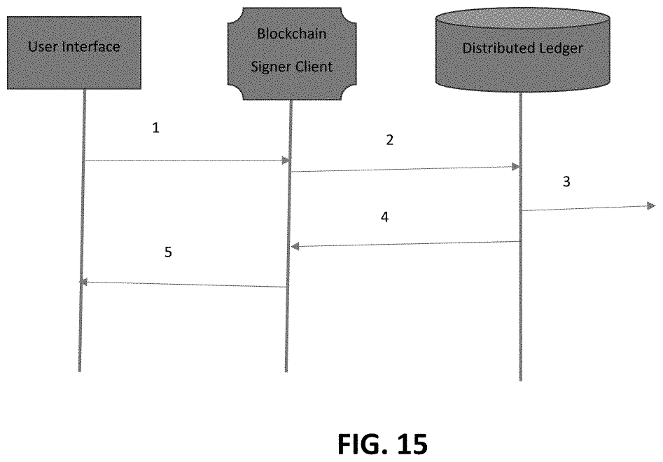

### Scenario 1: ERP Data. Pushed Via UI (FIG. 15)

(1) UI Module initiates a transaction from UI (Click a submit button or a user action)

(2) Blockchain Signer verifies the data and then identify the blockchain information and then. It will used private key to sign the transaction and send data and signature to Distribute ledger

(3) DL Node runs the smart contact, verify that transaction is coming from correct user/Organization by using user public Key and then after verification from all other entity within the network it will generate the transaction block and broadcast to all interested organization nodes. This logic varies based on different blockchain.

(4) It will also send notification to its own organization when data added successfully in the blockchain after consensus.

(5) The signer receives the data and store the transaction and other relevant information based on Block chain (BC) network to access the data in future and also updated the custom data response to UI module.

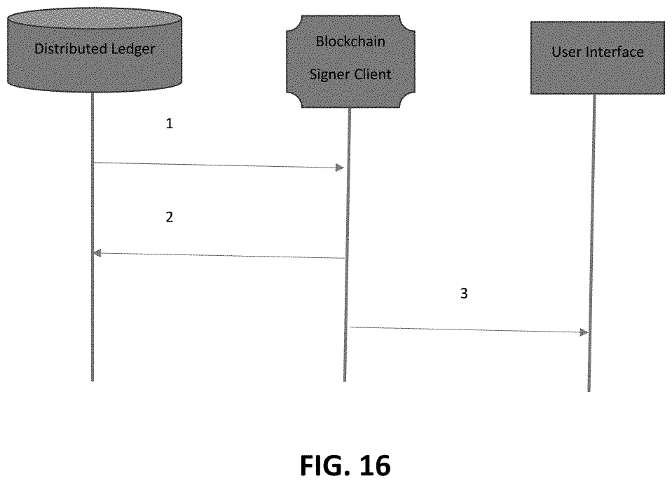

### Scenario 2: Transaction Receiver Module Call Flow (FIG. 16)

(1) DLT (Distributed Ledger Technology) emits an Event after successfully adding transaction created from other organization to the participant organization.

(2) Participant organization Blockchain signer fetch the complete transaction using transaction id in the events and then verify the transaction by verifying signature of all the participant origination using their public key.

(3) After verification is successful .it updates the business data based on other organization data and then notify that change to UI module.

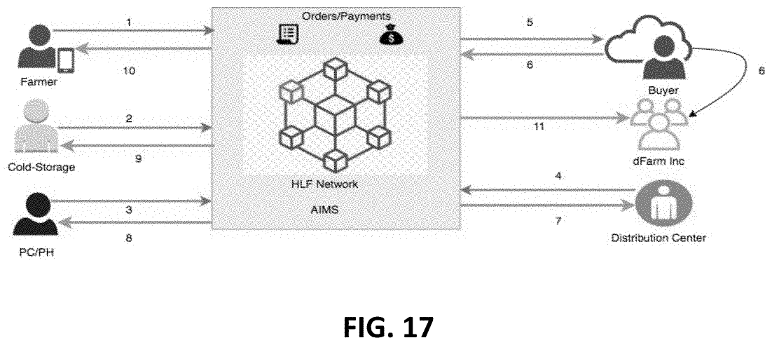

Basic flow for Invoice and Payments is as follows and shown in FIG. 17.
1. Farmer update AIMS BC module for forecasted delivery to its designated cold storage
2. After the harvesting when produce delivered to CS (Cold Storage), corresponding Invoice is created into AIMS BC with information, e.g., Farmer ID, CSID, quantity, etc.
3. PC (Processing Centre) looks for available quantity in CS via AIMS and then places order, based on booking it received from DC (Distribution Centre) or directly from bulk buyer.
4. If DC is receiving delivery from PC, then it generates order in AIMS BC.
5. If Buyer is receiving delivery, it generates orders to AIMS BC.
6. The buyer sends Payment to dFarm and then updates the status for payment to AIMS BC, then AIMS BC generates payable invoice for all parties.
7. AIMS BC send payment to DC if it is part of the generated invoice
8. It sends payment to PC based on generated invoice
9. It sends payment to CS based on generated invoice.
10. It sends payment to Farmer based on generated invoice
11. It sends payment to dFarm services entity based on generated invoice.

AIMS has implementation to support fragmented order payment based on whatever finally sold to buyer. AIMS has capability to support two ways to charge service fee for produce delivery between farmer and buyer: (1) Cumulative Mode; and (2) Tired Mode

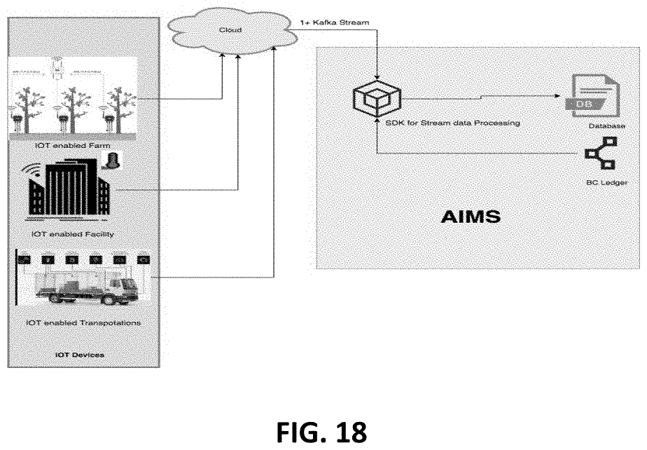

Track, Trace and Quality Control information collection from IOT Devices is shown in FIG. 18. AIMS includes inbuilt microservices to integrate with different IOT devices via multiple IOT Data providers using Kafka streaming, “Dell Boomi” software and direct Json based REST end points.

As illustrated in FIG. 18 which shows IOT based architecture, AIMS collects real time data like geo location, temperature and other required information from Farm, Trucks and Facility center IOT devices and push those data into AIMS database and blockchain ledger in Json format. It is using “Dell Boomi” to transform data from other format to Json before processing it for storage.

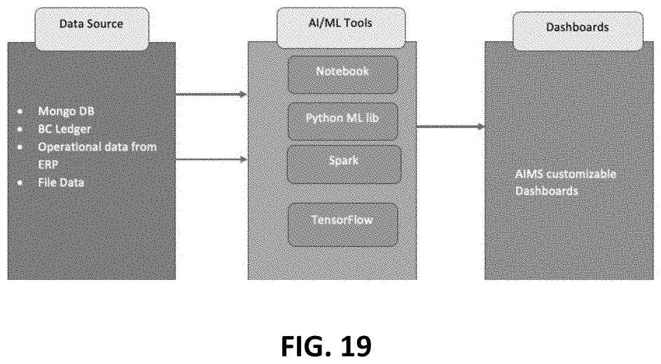

Inbuilt AI Framework for Data Processing and Dashboard Display is shown in FIG. 19.

The AIMS has in build Analytics module to analyze its database, file system and blockchain ledger data to provide dynamic chart and graphs based on selected properties like produce quality, produce tracking, forecasting etc.

### Open REST API For Other System to Integrate With AIMS

AIMS has a capability to grow list of public APIs to connect with legacy system to interact with overall supply chain. It also has web hooks that any auditor or government agency can subscribe to collect relevant information based on their interest.

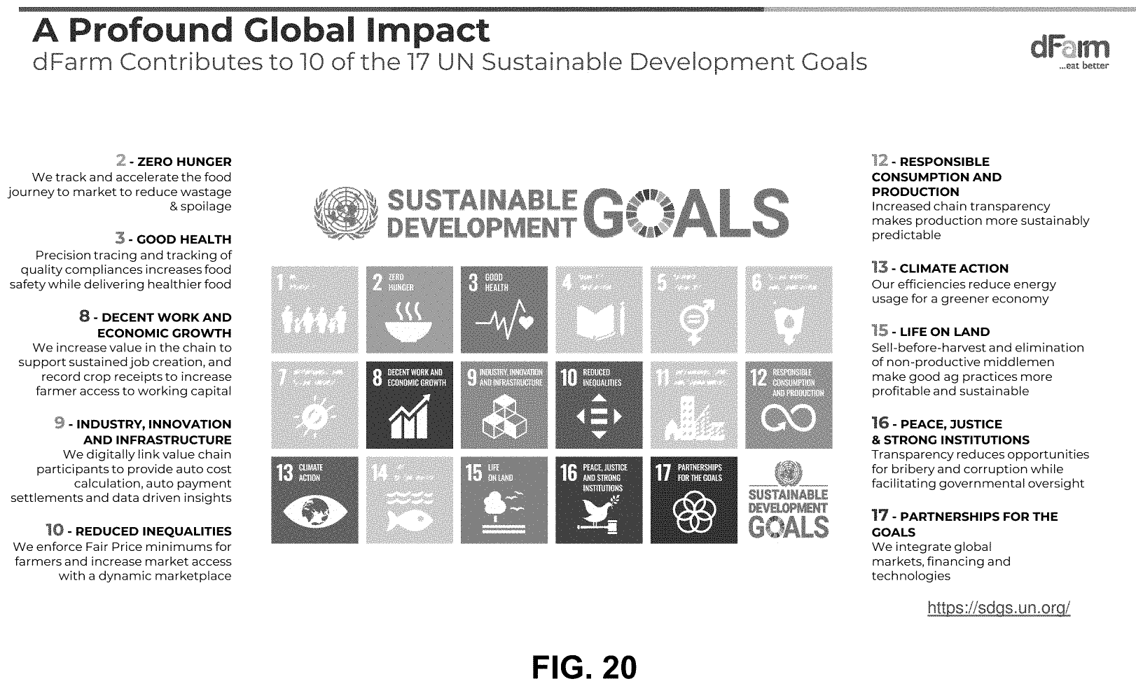

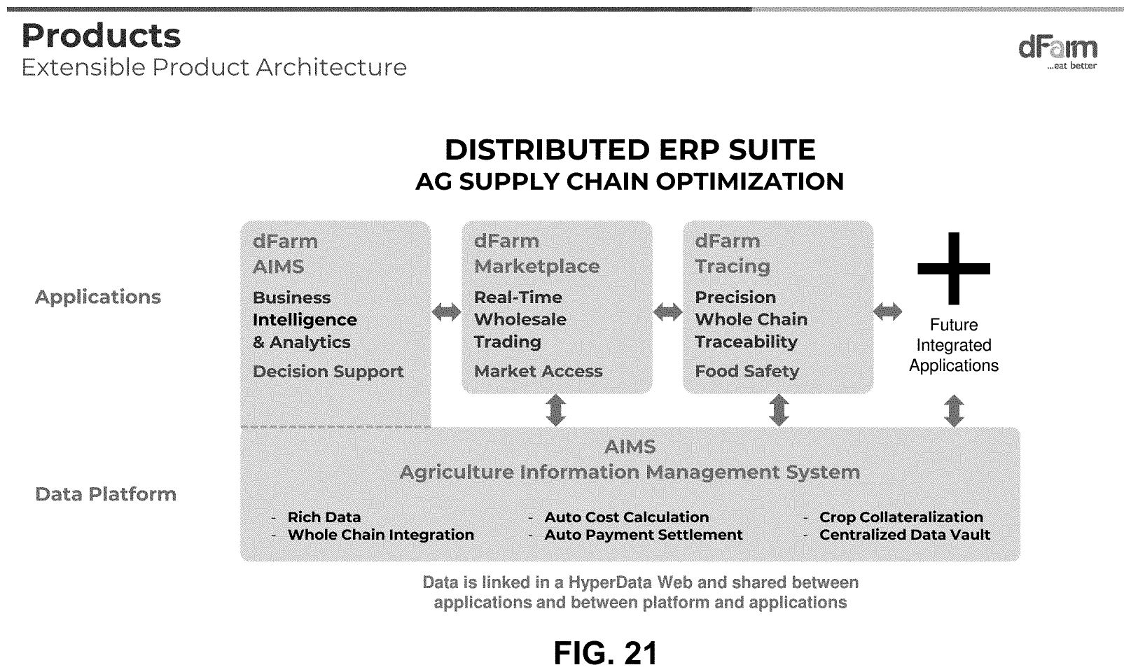

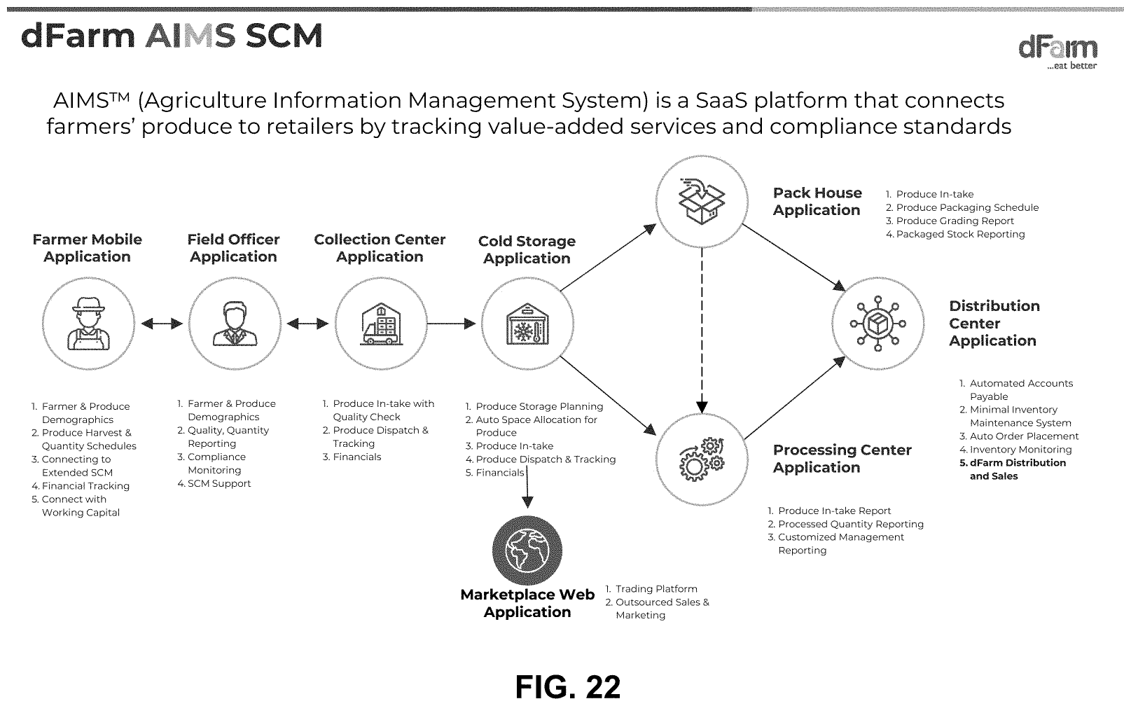

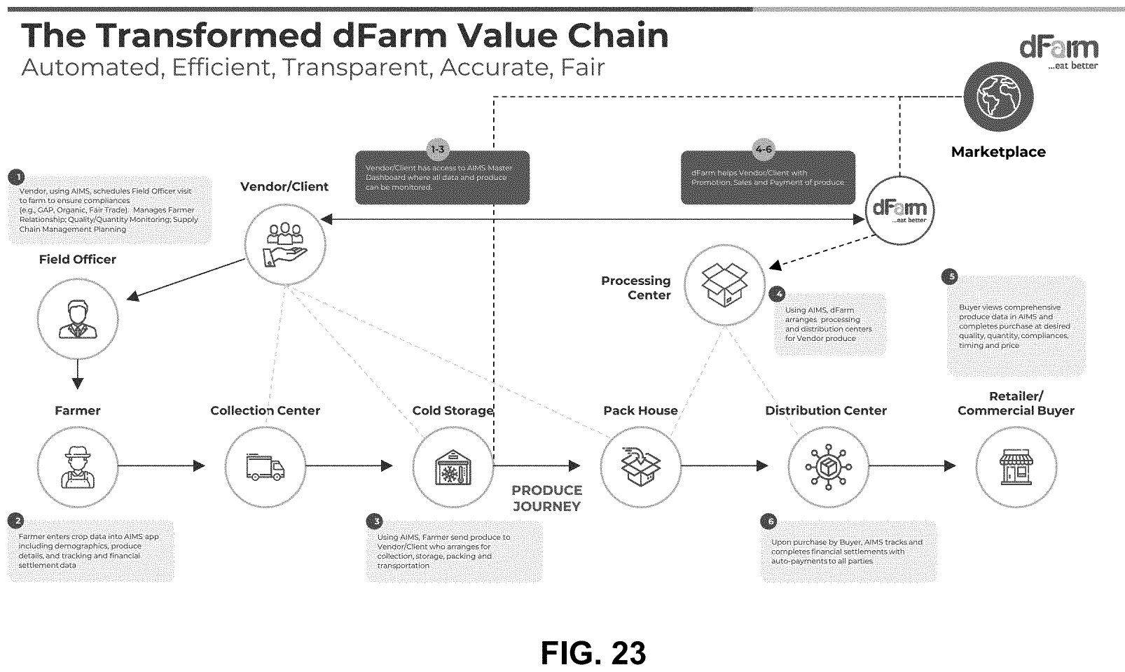

FIG. 20 illustrates a profound global impact of the AIMS showing the AIMS meeting the objective of Sustainable Development Group of the United Nations (UNSDG). As shown in FIG. 20, the AIMS meets 10 goals of UNSDG out of 17 including zero hunger, reduced inequalities, climate action, peace, justice and strong institution. FIG. 21 illustrates distributed ERP suite. FIG. 22 illustrates AIMS SaaS platform working model, FIG. 23 illustrates transformed dFarm value chain.

Although the present invention has been described herein with respect to several specific illustrative embodiments, the foregoing description is intended to illustrate, rather than to limit the invention. Those skilled in the art of IT will realize that many modifications of the illustrative embodiment can be made and would be operable. All such modifications, which are within the scope of the claims are intended to be within the scope and spirit of the present invention.

What is claimed is:

1. An integrated agriculture information and management system (AIMS) for supplying and managing movement of a produce from a farmer to a retailer, said AIMS comprising
a plurality of organizations each having a enterprise resource planning (ERP) module including one or more processors; and
a plurality of channels which selectively share business data between the ERP modules of the plurality of organizations;
wherein:
the plurality of the organizations include a farmer organization, a harvesting organization, a warehousing and packaging organization, a distribution and processing organization, a business organization, a compliance organization, and a retailer organization; and the plurality of the organizations are operatively connected with each other via the channels;
the movement of the produce from the farmer organization to the retailer organization is recorded in real time and instantaneously in the plurality of organizations, and when the produce is delivered to the retailer organization, the one or more processor selectively cause the business organization to release payments to the farmer organization, the harvesting organization, the warehousing organization, and the distribution and processing organization for the produce delivered to the retailer organization; and
when the price of the produce is declared by the farmer organization, each of the plurality of the organizations except for the farmer organization receive a corresponding preset service charge payment for the produce delivered to the retailer organization such that the price of the produce cannot be inflated or deflated by the plurality of the organizations.

2. An integrated agriculture information and management system according to claim 1, wherein the warehousing and packaging organization is configured to create a QR code which includes information related to farmer organization including farmer demographics, farm compliances, and cost of the produce and harvesting date and time declared by the farmer organization, and
wherein the QR code is continually updated as the produce moves from the warehousing and packaging organization to the plurality of the organizations including the retailer organization.

3. An integrated agriculture information and management system according to claim 2, further comprising
an user interface associated with respective each of the plurality of organizations;
a blockchain signer client operatively connected with each of said user interfaces; and
a distributed ledger having a plurality of nodes which operate within each of the plurality of organizations.

4. An integrated agriculture information and management system according to claim 3, wherein the user interface is operable to store at the respective one of the plurality of organizations, and to push data including one or more of invoice, price and registration to the blockchain signer.

5. An integrated agriculture information and management system according to claim 3, wherein the blockchain signer client includes a plurality of sub module operable to initiate data sharing within and across the plurality of organizations.

6. An integrated agriculture information and management system according to claim 3, wherein the distributed ledger is selectively operable to notify one or more of the plurality of organizations of one or more specific transactions based on a preset smart contract logic.

7. An integrated agriculture information and management system according to claim 3, wherein each of the plurality of nodes has a copy of immutable data which is updated based on a consensus protocol.

8. An integrated agriculture information and management system according to claim 3, wherein during operation the user interface initiates a transaction of data based on a user action; the blockchain signer client verifies the transaction of data received from the user interface, signs the transaction of data and the verified data to the distributed ledger; and at least one said node of the distributed ledger runs a smart contact, verifies that transaction of data is coming from an appropriate one of the plurality of organizations and generate a transaction block and broadcast to all concerned nodes of the plurality of organizations.

9. An integrated agriculture information and management system according to claim 3, wherein during operation the user interface of one of the farmer organization and the harvesting organization sends the blockchain signer client data regarding forecasted delivery of the produce to the warehousing and packaging organization which includes a cold storage.
